(19) United States
(12) Patent Application Publication
(10) Pub. No.: US 2006/0074797 A1
(43) Pub. Date: Apr. 6, 2006

(54) Accounting method and apparatus for intellectual property reinvestment fund

(75) Inventors: Luis J. Diaz, Green Brook, NJ (US); James A. Digiorgio, Green Brook, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/958,381

(22) Filed: Oct. 6, 2004

(51) Int. Cl. G06Q 40/00

(52) U.S. Cl. 705/39; 705/35

(57) ABSTRACT

A system of accounting is provided for an intellectual property trust that manages multiple intellectual property accounts and assets. The system provides for the allocation of new intellectual property assets to the trust and a determination of a unit value of those intellectual property assets. The system further provides for the entry of a transaction of those assets and a determination of the unit value of that transaction. The unit value of the transaction is posted to the unit values of the intellectual property assets and of the account. By comparing the unit value of the intellectual property assets and the account, a determination of the shareholdings of the beneficiaries in the corpus is made.

### BACKGROUND OF THE INVENTION

1. Field of the Invention

The present invention relates generally to a system of accounting for an intellectual property (hereinafter “IP”) trust having multiple beneficiaries and assets. More particularly, the present invention relates to a system of accounting in which the revenues generated by the IP assets of the trust are reinvested into a corpus of the trust, and in which the revenues are used to determine the respective corpus shareholdings of the beneficiaries that have allocated IP assets to the trust. IP assets may include any product of intellect that has commercial value, e.g., copyrights, trademarks, patents, know how and trade secrets.

2. Discussion of the Background

An investment trust creates a fiduciary relationship whereby an entity (the trustee) manages the property for the benefit of another person (the beneficiary). A dividend reinvestment plan is an investment vehicle whereby shareholder dividends are automatically reinvested into the issuing corporation, e.g., are used to purchase more shares of the corporation's stock.

Trusts and dividend reinvestment plans both pose significant benefits for their investors. Trusts, for instance, enable their investors to benefit from the expertise of those who manage the trust. Further, trusts can spread the risk of future losses and liabilities across a wide array of assets. Dividend reinvestment plans, for instance, stimulate capital investment by enabling their shareholders to accumulate stock without paying brokerage fees. Dividend reinvestment plans can also stimulate investment by providing tax advantages and dollar cost averaging benefits.

Recently, trusts have been suggested for managing the risk of maintaining patents, e.g., for managing the risk of future litigation costs that may arise from ownership of a patent. More particularly, in copending U.S. patent application Ser. No. (Attorney Docket No. 248602US), it has been proposed that such risks may be managed by allocating patents to an IP trust, and by further investing portions of the trust's corpus to offset future liability arising from those patents.

Of course, if the corpus does not include fluid capital for such investment, then the trust may have difficulty finding sufficient funds to achieve its purpose. For instance, where the beneficiaries have allocated their IP assets to the trust, but have not provided any accompanying cash allocation, the trust may have insufficient cash reserves to apply or invest against future liability. In addition, if the beneficiaries allocate their IP assets to the trust, the issue may arise as to how the beneficiaries should be compensated for the growth of the corpus that results from their allocated IP assets.

### SUMMARY OF THE INVENTION

Against that background, the present invention provides a method of managing an IP trust. More particularly, the present invention provides a method of generating additional corpus for an IP trust, through the reinvestment of revenues generated by the IP assets allocated to the trust. The method includes the steps of entering a transaction of an IP asset, determining a transaction unit value of the transaction, and posting the transaction unit value to a total unit value of the fund.

Further, the present invention provides a method of adjusting the shareholdings of the beneficiaries in the corpus, based on the revenues generated by the respective IP assets the beneficiaries have allocated to the trust. That method includes, in addition to the above steps, posting the transaction unit value to an account containing the IP asset, and comparing a total unit value of the account to the total unit value of the fund in order to determine a share of the account in the fund.

In addition, the present invention provides an apparatus for implementing the above methods. More particularly, the present invention provides a computer readable medium that stores instructions causing a computer to perform the above steps.

### BRIEF DESCRIPTION OF THE DRAWINGS

A more complete appreciation of the invention and many of the attendant advantages thereof will be readily obtained as the same becomes better understood by reference to the following detailed description, and when considered in connection with the accompanying drawings, wherein:

FIG. 1 illustrates a process flow chart showing steps used to generate additional corpus for an IP trust, through the reinvestment of revenues generated by the IP assets of the trust, according to a non-limiting embodiment of the present invention;

FIG. 2 illustrates a process flow chart showing steps used to adjust the shareholdings of the beneficiaries in the corpus, according to a non-limiting embodiment of the present invention;

FIG. 3 illustrates a computer that may be used to implement the steps discussed with respect to FIGS. 1 and 2.

### DESCRIPTION OF THE EMBODIMENTS

There are various reasons for creating an IP trust. One reason is to spread unknown risks for individual IP assets, such as future litigation costs, amongst the collective IP assets of the trust. However, investors may be wary of investing cash, as well as their respective IP assets, to guard against such risks. Such apprehension would be particularly prevalent when a slow economy or other financial constraints have already diminished funding for research and development of new technologies. Thus, an IP trust can benefit from unconventional sources of revenue.

Dividend reinvestment plans have found recent favor in generating capital that might not otherwise be obtained through traditional investment. For instance, dividend reinvestment plans have been recently successful in generating capital for Real Estate Investment Trusts, which are typically mutual funds that purchase high yield real estate properties with lower yield capital raised from the public.

However, dividend reinvestment plans suffer from several shortcomings, especially where such plans pertain to publicly traded stocks. More particularly, when investors directly purchase shares through dividend reinvestment plans, the demand for such shares can decrease on the open market. Further, if such investors quickly resell those shares, the supply of such shares can increase on the open market. Of course, decreased demand and increased supply can result in depleted share values.

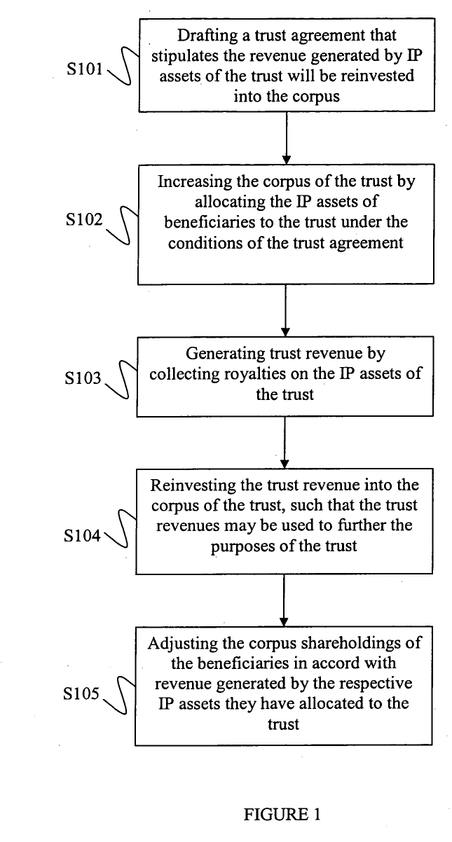

In addition, dividend reinvestment plans may be constrained by governmental regulations. For instance, while Real Estate Investment Trusts provide federal tax savings to their investors, the Internal Revenue Code has required that these trusts pay out at least 95% of their earnings. Such constraints can make it difficult to raise significant capital through reinvestment earnings. As explained with respect to FIG. 1, the present embodiment is less susceptible to the shortcomings of dividend reinvestment plans.

FIG. 1 illustrates a non-limiting example of how the revenue generated from the IP assets of an IP trust, e.g., corpus dividends, might be reinvested into the trust corpus. As shown, the trust is first established S101 by drafting a trust instrument stipulating the objectives of the trust. In addition, the instrument may stipulate the manner in which the beneficiaries' allocated IP assets will be managed. More particularly, the trust instrument may stipulate that the revenue from the trust's IP assets will be reinvested into the corpus.

Next, the corpus is established in S102 by the allocation of the beneficiaries' IP assets to the trust. Preferably, the allocated IP assets of the trust are allocated solely by beneficiaries, in furtherance of collectively guarding against future liability arising from those IP assets. However, the IP assets could be acquired by purchase or by an exchange of other IP assets and rights, e.g., via an exchange of other patents licensing rights. In this embodiment, the IP assets include only patents, but any type of IP asset could be included.

Once the corpus is established S102, revenue may be generated S103 from the IP assets of the trust. Such revenue need not be limited to patent licensing fees, but may also include other derived items of commercial value, e.g., litigation windfalls, that may be reinvested into the corpus.

Of course, investors may not wish to invest their more profitable IP assets, unless the investors are sufficiently assured they will receive a return that is commensurate with the revenues generated by those IP assets. Thus, the beneficiaries' individual shareholdings in the corpus should be adjusted (see S105) in view of the revenues generated by the IP assets that they have allocated to the trust.

The method of FIG. 1 has several advantages. One advantage is that as the IP trust of the present embodiment is a privately held trust, in which the beneficiaries obtain shares by allocating individually owned IP assets to the corpus, the trust is less susceptible to the share devaluations that occur when dividend reinvestment plans are utilized for publicly traded securities. Further, as the trust is managed to guard against the risk of future liabilities incurred by its IP assets, the trust is less susceptible to the shortcomings of funds that are managed solely to maximize yields based on the market.

The benefits of the trust can extend beyond the protection's against share value fluctuations and the spreading of monetary risk across a portfolio of IP assets. For instance, if a patent of the trust is the subject of an infringement lawsuit, any other patent of the trust may be asserted against an adverse party of that lawsuit. Similarly, if a patent of the trust is for an improvement of someone else's patented product or for a device including a component patented by another entity, any other patent of the trust may be used to influence a third party to provide the necessary licenses. Patent rights and licenses could be exchanged with other entities to settle legal disputes, to diversify the trusts corpus, or strengthen the trust's position in particular areas of commerce, etc.

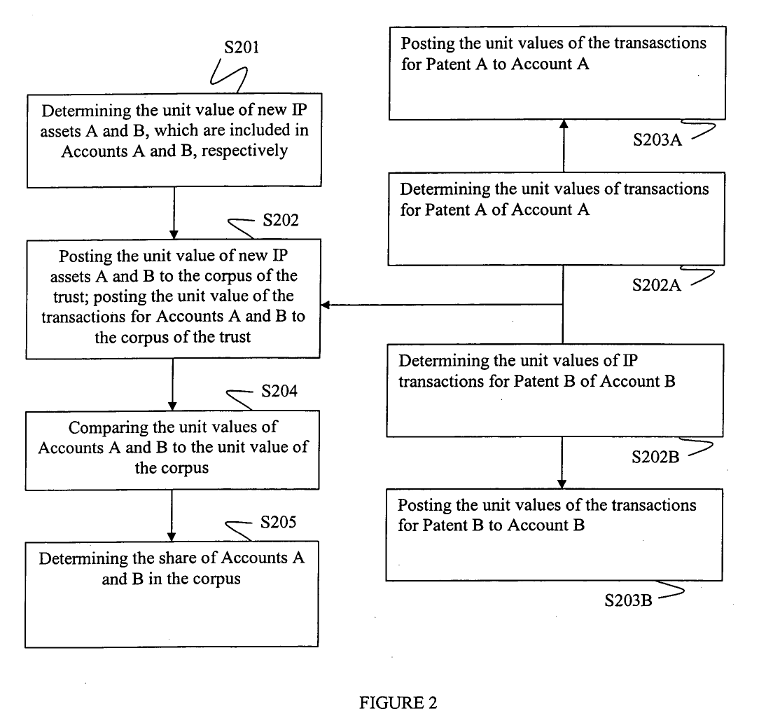

The present embodiment presumes that prospective beneficiaries will allocate their IP assets to the trust in return for protection against future liability. As stated above, however, prospective beneficiaries may be unwilling to allocate their more profitable IP assets to the trust unless they are assured that they will receive a share of the corpus that is commensurate with the revenues generated by their allocated assets. Thus, as explained with reference to FIG. 2, a method for adjusting the corpus shareholdings of the beneficiaries, corresponding to step S105, is described below.

As shown in FIG. 2, the established corpus is assigned a unit value in S201, which is based upon the aggregate unit values of the IP assets held by the trust. The unit values may be monetary values, such as U.S. dollar amounts, or any arbitrary or real elementary constituent. The present embodiment utilizes a unit value that is based upon an IP asset's market value. Any number and combination of factors may be taken into consideration, especially where such factors confer a value or incur a detriment (monetary or otherwise) upon the beneficiaries or the IP trust itself. Some of the factors that may be taken into consideration include: acquisition costs (e.g., purchase price and brokerage legal fees); the remaining length of the patent term; the range of products covered; the validity of the patent; the likelihood and expense of litigation; the exclusionary power and likelihood that the patent can be enforced without raising antitrust issues; lead time to market; complex versus discrete technology; and systemic versus autonomous innovation.

For example, a unit value could be determined using a discounted net present value calculation that is based on projected revenue or a projected stream of assets. Alternatively, if no revenue or stream of assets is projected, the net present value could be calculated using a cost method, e.g., the costs to develop and maintain the patent. Of course, all of the above factors could be used in a more comprehensive calculation.

As shown in S202, the transactions of the IP assets are also assigned a unit value. Such transactions may include positive entries that are associated with licensing fees, litigation windfalls, depreciation, or other sources of value derived from the IP assets. Such transactions may also include negative entries that are associated with litigation costs, promotional costs, taxes, or other losses. Similar to the unit value of the corpus, the unit value of the IP asset transactions need not be established in monetary units.

In the present embodiment, Accounts A and B include Patents A and B, respectively, but could include any IP asset. The exemplary transactions of the Patent A include positive entries for licensing revenue and depreciation costs, which may offset taxes. The non-limiting transactions of Patent B include positive entries for licensing fees and litigation windfalls, and a negative entry for attorneys fees associated with the generation of compliance and opinion letters. However, as stated above, less tangible benefits and losses may be recognized for each IP asset.

Once the unit values for the transactions of Accounts A and B have been determined by S202A and S202B, the unit values of those transactions are posted to the unit values of Accounts A and B via S203A and S203B, respectively. As shown in S202, the unit values of those transactions are also posted to the corpus of the trust. Preferably, the unit values of the transactions may be directly compared to the unit values of the corpus and of the accounts, e.g., dollars to dollars, such that the unit values of the transactions may be directly added. However, alternative formulas may be provided for posting the unit values of the transactions.

For instance, the unit values of the transactions may be weighted in accord with the recentness in which the corresponding IP asset or account was allocated to the trust. As a non-limiting example, if new assets could provide greater postings to their respective accounts, then account holders would be encouraged to allocate new IP assets to the trust. Further, the weighting of the unit values of the transactions may also depend upon whether these values are being posted to the corpus or the respective account.

By way of example, once the unit values of the corpus and Accounts A and B are updated via S202, the unit values of the corpus and those accounts may be compared in order to determine the updated shareholdings of the beneficiaries. Preferably, that determination would result in a pro-rata share for the beneficiaries, based on the transaction contributions of their accounts. However, other computations may be used. Again, such computations may take into account, for instance, the recentness with which the respective IP asset or account was allocated to the trust.

In addition, such computations may weigh, for example, the contributions of other IP assets of the account, in order to reward consistently performing accounts, e.g., to reward accounts for IP assets that have not incurred substantial litigation costs.

In the present embodiment, the unit values of the corpus and accounts are compared after the unit value of the transactions have been posted to both the corpus and the accounts. Alternatively, the unit values of the transactions may be posted to only the corpus before the comparison S204 is performed. Thus, since the transactions are posted to the accounts after the comparison S204, only the prior performance of accounts would be given weight in determining the beneficiaries' shareholdings. On the other hand, where the transactions are posted only to the accounts before the comparison S204, the most recent performance of the accounts is given greatest consideration in determining corpus share.

This invention may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

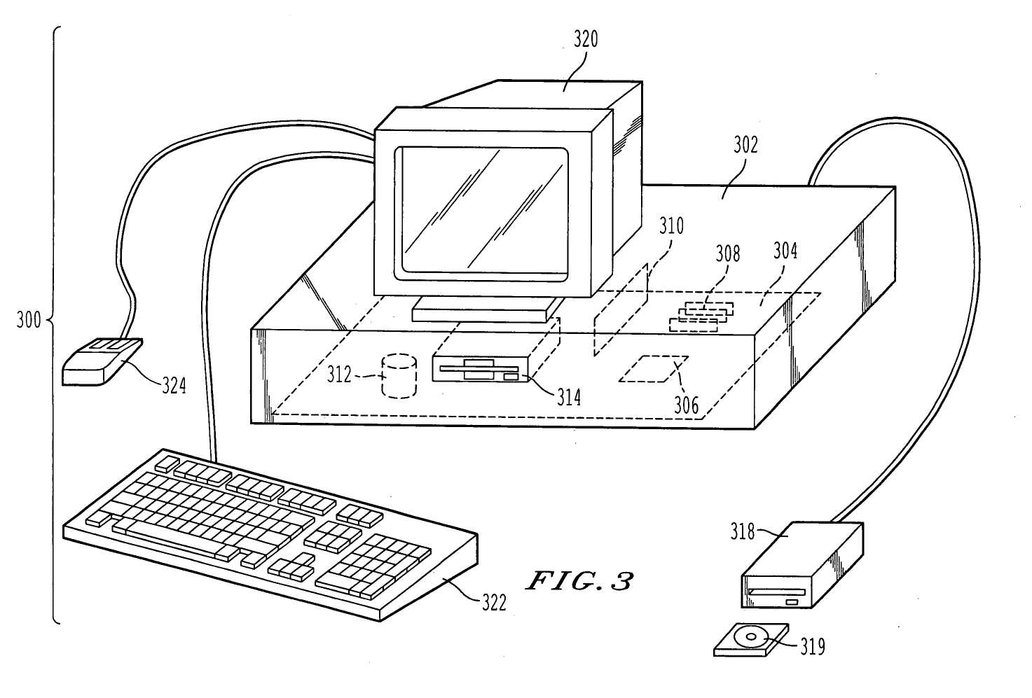

A non-limiting example of a computer 300, as shown in FIG. 3, may be used to implement the method of the present invention, wherein the computer housing 302 houses a motherboard 304 containing a CPU 306, memory 308 (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer 300 also includes plural input devices, (e.g., keyboard 322 and mouse 324), and a display card 310 controlling a monitor 320.

Additionally, the computer 300 may include a floppy disk drive 314; other removable media devices (e.g. compact disc 319, tape, and removable magneto-optical media (not shown)); and a hard disk 312 or other fixed high density media drives, connected via an appropriate device bus (e.g., a SCSI bus, an Enhanced IDE bus, or an Ultra DMA bus). The computer may also include a compact disc reader 318, a compact disc reader/writer unit (not shown), or a compact disc jukebox (not shown), which may be connected to the same device bus or to another device bus.

As stated above, the system includes at least one computer readable medium. Examples of computer readable media are compact discs 319, hard disks 312, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer 300 and for enabling the computer to interact with a human user. Such software may include, but is not limited to, device drivers, operating systems and user applications, such as development tools.

Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost.

The invention may also be implemented by the preparation of application specific integrated circuits or by interconnecting an appropriate network of conventional component circuits, as will be readily apparent to those skilled in the art.

Obviously, numerous modifications and variations of the present invention are possible in light of the above teaching. It is therefore to be understood that within the scope of the appended claims, the invention may be practiced otherwise than as specifically described herein.

1. A method of accounting, the method comprising:
entering a transaction of at least one intellectual property asset;
determining a transaction unit value of the transaction; and
posting the transaction unit value to a total unit value of an intellectual property fund.

2. The method according to claim 1, further comprising:
posting the transaction unit value to an account containing at least one intellectual property asset; and
comparing a total unit value of the account to the total unit value of the fund to determine a relative share of the account in the fund.

3. The method according to claim 2, wherein the fund includes a plurality of accounts each containing at least one intellectual property asset.

4. The method according to claim 3, wherein the total unit value of the account includes a unit value of the at least one intellectual property asset and the transaction unit value posted to the account, and
the total unit value of the fund represents a sum of total unit values of the plurality of accounts.

5. The method according to claim 1, wherein the transaction includes revenue derived from the intellectual property asset.

6. The method according to claim 5, wherein the transaction further includes losses attributed to the intellectual property asset.

7. The method according to claim 4, wherein the intellectual property fund includes a privately held intellectual property trust.

8. A computer readable medium storing program instructions, which when executed by a computer system causes the computer system to perform a method of accounting for an intellectual property fund, the method comprising:
entering a transaction of at least one intellectual property asset;
determining a transaction unit value of the transaction; and
posting the transaction unit value to a total unit value of the fund.

9. The computer readable medium according to claim 8, wherein the method further comprises:
posting the transaction unit value to an account containing the at least one intellectual property asset; and
comparing a total unit value of the account to the total unit value of the fund to determine a share of the account in the find.

10. The computer readable medium according to claim 9, wherein the fund includes a plurality of accounts each containing the at least one intellectual property asset.

11. The computer readable medium according to claim 10, wherein the total unit value of the account includes a unit value of the at least one intellectual property asset and the transaction unit value posted to the account, and
the total unit value of the fund represents a sum of total unit values of the plurality of accounts.

12. The computer readable medium according to claim 8, wherein the transaction includes revenue derived from the intellectual property asset.

13. The computer readable medium according to claim 12, wherein the transaction further includes losses attributed to the intellectual property asset.

14. The computer readable medium according to claim 11, wherein the intellectual property fund is a privately held intellectual property trust.
